(19) United States
(12) Patent Application Publication
(10) Pub. No.: US 2019/0095949 A1
(43) Pub. Date: Mar. 28, 2019

(54) Digital Marketing Content Control based on External Data Sources

(71) Applicant: Adobe Systems Incorporated, San Jose, CA (US)

(72) Inventors: Jen-Chan Jeff Chien, Saratoga, CA (US); Thomas William Randall Jacobs, Cupertino, CA (US); Kent Andrew Edmonds, San Jose, CA (US); Kevin Gary Smith, Lehi, UT (US); Peter Raymond Fransen, Soquel, CA (US)

(73) Assignee: Adobe Systems Incorporated, San Jose, CA (US)

(21) Appl. No.: 15/716,348

(22) Filed: Sep. 26, 2017

(51) Int. Cl. G06Q 30/02; G06Q 50/00; G06N 99/00; G06N 7/00

(52) U.S. Cl. CPC G06Q 30/0255; G06Q 30/0275; G06N 7/005; G06N 99/005; G06Q 50/01

(57) ABSTRACT

Techniques and system are described to control output of digital marketing content with respect to digital content. This is achieved by leveraging additional insight that may be gained from external service systems that describe the digital content, e.g., social network systems, digital content review systems, and so forth. In one example, the techniques and systems are configured to collect social network data that describes social network communications communicated via a social network system. Natural language processing techniques are then performed as part of machine learning to detect interest of a user population associated with the social network communications.

### BACKGROUND

Conventional digital marketing systems are configured to make judgements regarding which items of digital marketing content to provide based on particular users and past user interactions with digital marketing content undertaken by those users. For example, conventional techniques and systems have been developed to identify segments of a user population and interaction of those segments with items of digital marketing content, such as whether this interaction resulted in conversion of a good or service. This knowledge is then used as a basis to select subsequent items of digital marketing content for output to particular user segments. Thus, knowledge of the user segments and past interactions is used to increase a likelihood that exposure of digital marketing content selected with these user segments in mind will increase a likelihood of conversion.

While these conventional techniques have been successful in increasing this likelihood of conversion, these techniques ignore potentially useful information that may further increase this likelihood. This is especially true in scenarios in which the digital marketing content is to be output with respect to “live” digital content, e.g., digital video that is streamed of a sporting event. A zero/zero tie in the middle of the sporting event, for instance, may cause a user population to engage with other digital content (e.g., “change the channel”), thereby reducing a value of output of digital marketing content. However, a zero/zero tie and subsequent overtime in that same sporting event may cause an increase in this user population, and thus increase a value of output of digital marketing content. Conventional digital marketing systems, however, are incapable of addressing these differences. This results in a computational and network inefficiencies in conventional digital marketing system through inaccuracies in gauging the value of these opportunities.

### SUMMARY

Techniques and system are described to control output of digital marketing content with respect to digital content, e.g., streaming videos, webpages, and so on. This is achieved by leveraging additional insight that may be gained from external service systems that describe the digital content, e.g., social network systems, digital content review systems, and so forth. In this way, the techniques and systems are configured to address nuances of a wider range of digital content, including live streaming digital content that is not possible using conventional techniques.

In one example, the techniques and systems are configured to collect social network data that describes social network communications communicated via a social network system. Natural language processing techniques are then performed as part of machine learning to detect interest of a user population associated with the social network communications. In a first example, interest indicates a level of interest in the digital content by the user population via a score, i.e., is the user population likely watching or not watching a television show. In a second example, interest indicates a sentiment expressed by the user population with respect to the digital content. As a result, the digital marketing system may react in real time as insights are gained from the social network system to control output of digital marketing content, even for live streaming digital content which is not possible using conventional techniques and systems.

Knowledge of topics that are the subject of social network communications may also be leveraged to improve accuracy and efficiency of operation of the digital marketing system. The digital marketing system, for instance, may obtain social network data that describes a plurality of topics involving social network communications. The digital marketing system then identifies which topics are relevant to digital marketing content based on respective social network communications associated with the topics. A score is then generated through natural language processing by the scoring module to indicate whether the identified topics are likely to have a negative or positive effect on conversion of a good or service associated with the digital marketing content, e.g., based on a sentiment expressed by respective communications learning through natural language processing. As a result, the digital marketing system may select digital marketing content with increased accuracy by leveraging an external service system, e.g., a social network system. Other external service systems are also contemplated, including digital content reviews from service provider systems. A variety of other examples are also contemplated as further discussed in the

### DETAILED DESCRIPTION

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 is an illustration of an environment in an example implementation that is operable to employ digital marketing content control techniques described herein.

FIG. 2 depicts a system in an example implementation in which output of digital marketing content is controlled based on a determination of user interests regarding digital content as determined from an external service system.

FIG. 3 depicts a system showing operation of a social network system of FIG. 2 in greater detail as generating social network data for use by a digital marketing system to gain insight into user interests.

FIG. 4 depicts a system in an example implementation showing operation of the digital marketing system in greater detail as employing natural language processing to process the social network data of FIG. 3 to generate a score usable to control output of digital marketing content based on user interests.

FIG. 5 depicts operation of a machine learning module of the scoring module of FIG. 4 in greater detail to perform natural language processing.

FIG. 6 depicts a procedure in an example implementation in which a score is generated through natural language processing to indicate user interests.

FIG. 7 depicts a system in an example implementation in which topics of a social network system are used, in part, to control output of digital marketing content.

FIG. 8 depicts a system in an example implementation in which operation of a natural language processing module is shown in greater detail as generating a score for a topic.

FIG. 9 is a flow diagram depicting a procedure in an example implementation of identification of topic correlation to digital marketing content is used to control output of the digital marketing content.

FIG. 10 illustrates an example system including various components of an example device that can be implemented as any type of computing device as described and/or utilize with reference to FIGS. 1-9 to implement embodiments of the techniques described herein.

### DETAILED DESCRIPTION

Overview

Techniques and system are described to control output of digital marketing content with respect to digital content. This is achieved by leveraging additional insight that may be gained from external service systems that describe the digital content, e.g., social network systems, digital content review systems, and so forth. In this way, the techniques and systems are configured to address nuances of a wider range of digital content, including live streaming digital content that is not possible using conventional techniques.

In one example, the techniques and systems are configured to collect social network data that describes social network communications communicated via a social network system. Natural language processing techniques are then performed as part of machine learning to detect interest of a user population associated with the social network communications. Interest may express a variety of types of interactions of the user population with respect to the digital content.

In a first example, interest indicates a level of interest in the digital content by the user population via a score, i.e., is the user population likely watching or not watching a television show. The score, for instance, may vary from “−1” to “+1” to indicate relative amounts of interest, e.g., from “not interested” to “interested.” The amounts of interest are determined through parsing the social network communications by a scoring module based on natural language understanding through machine learning to determine “how” interested, generally, the user population is in the digital video.

Keywords in the social network communications, for instance, may be located by the scoring module that indicate lack of interest (e.g., “I'm bored with #TV-show”) or a high degree of interest (e.g., “#TV-show is so cool!”) in the digital content. These keywords are then used by the scoring module to define a score, e.g., a level of interest. The score is then used by a digital marketing system to control output of digital marketing content, such as to control an amount to bid to cause output of digital marketing content in conjunction with the digital content as part of an online auction. In this way, the digital marketing system is able to gain and leverage valuable insight into the digital content from an external service system, even for live streaming digital content, which is not possible by conventional techniques that are limited to use of past user interactions.

Interest may also indicate a sentiment expressed by the user population with respect to the digital content. As above, the social network communications are obtained by the digital marketing system. Natural language understanding techniques are then employed as part of machine learning to learn sentiment expressed in the text, graphical elements (emoji's), and so on in the social network communications. The sentiments, of instance, may vary from “#sportingevent is truly awful” to “I love watching this #sportingevent, one of the best ever.” A score generated from this information by the scoring module may thus exhibit which sentiments are exhibited by the user population and even amounts of those sentiments (e.g., from “−1” to “+1”), which may give further insight into potentially successful digital marketing content.

The digital marketing system, for instance, may select digital marketing content consistent with these sentiments. Continuing with the example above, this may include selection of digital marketing content having the statement “well, at least you have your health” from a health care provider. This selection is made in this example in response to social network communications that indicate the user population thinks, generally as learned through natural language processing of the communications, that “#sportingevent is truly awful.” On the other hand, digital marketing content is selected indicating “we're winners, just like #teamx at #sportingevent” when natural language processing of the social network communications indicates that the user population thinks, generally, that “I love watching this #sportingevent, one of the best ever.” As a result, the digital marketing system may react in real time as insights are gained from the social network system to control output of digital marketing content, even for live streaming digital content which is not possible using conventional techniques and systems.

External source systems may also be used to improve accuracy in the selection of digital marketing content by the digital marketing system through the use of topics. The digital marketing system, for instance, may obtain social network data that describes a plurality of topics involving social network communications, e.g., trending topics associated with respective hash tags. The digital marketing system then identifies which of topics are relevant to digital marketing content based on respective social network communications associated with the topics. The social network communications, for instance, may be processing using natural language understanding to determine whether the communications include product mentions, are in the same field of endeavor, involving similar activities, and so forth.

A score is then generated by the scoring module to indicate whether the identified topics are likely to have a negative or positive effect (e.g., from “−1” to “+1”) on conversion of a good or service associated with the digital marketing content. Natural language processing techniques, and in particular natural language understanding, may be employed to determine whether sentiments expressed in the social network communications are considered positive or negative with respect to the digital marketing content. The digital marketing content, for instance, may relate to a beach scene. The topic, however, may relate to flooding. Accordingly, the digital marketing content is relevant to the topic, but would have a negative effect on conversion of a service, e.g., to purchase a corresponding beach vacation. As a result, through use of natural language processing, the digital marketing system may select digital marketing content with increased accuracy by leveraging an external service system, e.g., a third-party social network systems. Other external service systems are also contemplated, including digital content reviews from service provider systems.

In the following discussion, an example environment is first described that may employ the techniques described herein. Example procedures are also described which may be performed in the example environment as well as other environments. Consequently, performance of the example procedures is not limited to the example environment and the example environment is not limited to performance of the example procedures.

Example Environment

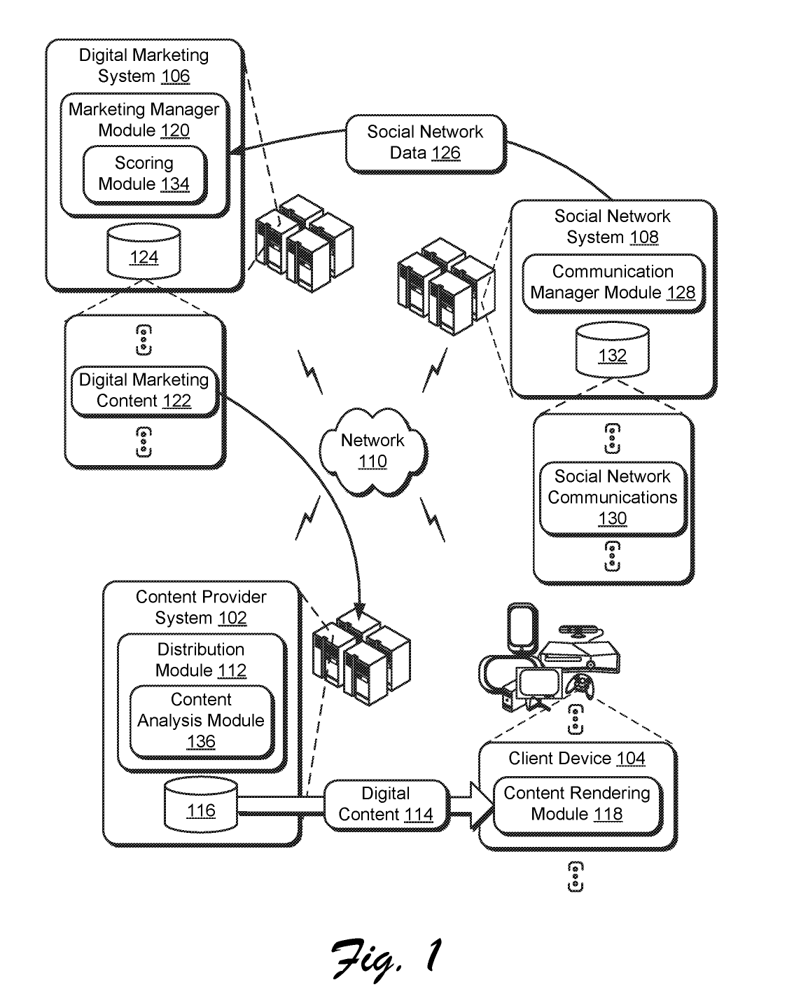

FIG. 1 is an illustration of a digital medium environment 100 in an example implementation that is operable to employ techniques described herein. The illustrated environment 100 includes a content provider system 102, client device 104, digital marketing system 106, and social network system 108 that are communicatively coupled, one to another, via a network 110. Computing devices that implement these systems and client devices may be configured in a variety of ways.

A computing device, for instance, may be configured as a desktop computer, a laptop computer, a mobile device (e.g., assuming a handheld configuration such as a tablet or mobile phone as illustrated for the client device 104), and so forth. Thus, the computing device may range from full resource devices with substantial memory and processor resources (e.g., personal computers, game consoles) to a low-resource device with limited memory and/or processing resources (e.g., mobile devices). Additionally, although a single computing device is described in instance of the following, a computing device may be representative of a plurality of different devices, such as multiple servers utilized by a business to perform operations “over the cloud” as shown for the content provider system 102, the digital marketing system 106, and the social network system 108.

The content provider system 102 is illustrated as including a distribution module 112. The distribution module 112 is implemented at least partially in hardware of the content provider system 102 (e.g., processing system and computer readable storage media) to provide digital content 114 to the client device 104 via the network 110, e.g., the Internet. The digital content 114 is illustrated as stored by a storage device 116. Digital content 114 may take a variety of forms, such as digital video, webpages, audio data, virtual or augmented reality content, and so forth. Consequently, communication of the digital content 114 may take a variety of forms, such as in response to an HTTP request, streaming performed in response to a series of calls made via a manifest and content segments, and so forth. The digital content 114, upon receipt by the client device 104, is then rendered for output by a content rendering module 118, e.g., network-enabled application, browser, and so forth for output by a display device, audio communication device, tactile device, and so forth.

The digital medium environment 100 also includes a digital marketing system 106. A marketing manager module 120 is included as part of this system to manage and control selection of digital marketing content 122 (stored by storage device 124) for output in conjunction with the digital content 114 to the client device 104. The digital marketing content 122 may take a variety of forms, such as banner ads, splash screens, digital video, and so forth that may be rendered by the client device 104.

To do so, the marketing manager module 120 is configured to leverage external sources of data (i.e., external service systems) to gain insight into digital content 114 that is communicated to the client device 104. These techniques, for instance, may support insight into “live” streaming digital content 114 (e.g., awards show, sporting event over television, radio, and so forth) that may be used to gain insight to improve accuracy in selection of digital marketing content 122, which is not possible using conventional techniques.

An example of an external service system is illustrated as a social network system 108 that is configured to communicate social network data 126 to support this insight. The social network system 108 includes a communication manager module 128 that includes functionality to create, communicate, and manage storage of social network communications 130, which are illustrated as stored by a storage device 132. The social network communications 130 are configurable in a variety of ways, such as text, digital images, emoticons, digital video, and so forth that are communicated between users of the system. Access to the social network communications 130 is managed by the communication manager module 128 to these users via permissioning to control which users of the social network system 108 are able to view and respond to the social network communications 130, e.g., as “friends,” “followers,” “family,” “co-workers,” and so forth.

The digital marketing system 106, through access to the communication manager module 128 via an application programming interface, requests social network data 126 that describes the social network communications 130. As a result, the digital marketing system 106 may gain insight from this data to manage selection of digital marketing content 122 with increased computational efficiency and accuracy over conventional techniques that made a “best guess” based on past user interaction with digital marketing content 122.

The social network communications 130, for instance, may include keywords (e.g., as hashtags) that are usable to reference digital content 114 being communicated to the client device 104. Hashtags are used by the social network communications 130 as an index the social network communications 130. Therefore, hashtags may be used to reference the digital content 114 (e g, name of the digital content 114), content included as part of the digital content 114 (e.g., names of actors, geographic locations, genre), and so forth. A user of the social network system 108, for instance, may post “#ParticularTVshow is awesome” as a social network communication 130 while watching the TV show. Selection of the keyword (e.g., “#ParticularTVShow”) by the user may cause the social network system 108 to output social network communications 130 generated by other users as part of a shared experience while watching the digital content 114.

The digital marketing system 106 may also leverage these keywords to gain insight into consumption of the digital content 114 by the client devices 104, and may do so in real time. The digital marketing system 106, for instance, may make a request via an API for social network data 126 that pertains to a particular keyword, e.g., the hashtag above. The social network data 126, for instance, may include a subset of the social network communications 130 that include that keyword. From this, the marketing manager module 120 employs a scoring module 134 to generate a score based on natural language processing that is usable to control selection and output of digital marketing content 122 for use in conjunction with the digital content 114.

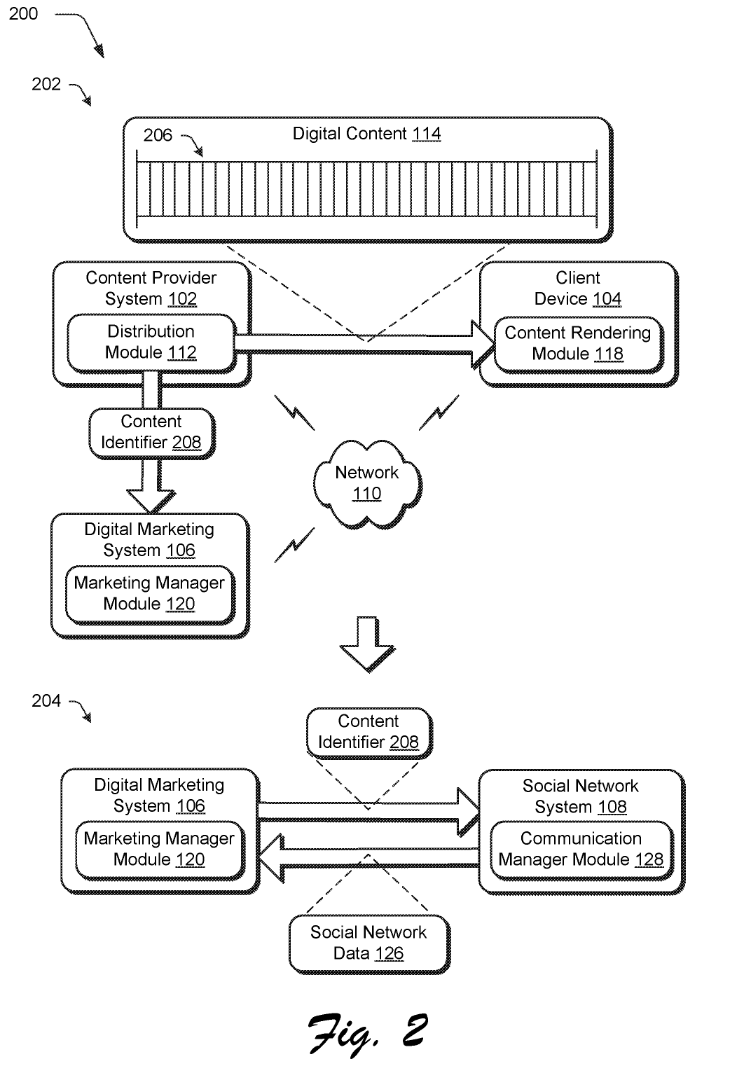

The scoring module 134 may generate the score to describe a variety of user interactions indicated as part of the social network communications 130, and from this, control output of the digital marketing content 122. In a first example, a score generated by the scoring module 134 indicates a level of interest in the digital content by the user population via a score, i.e., is the user population likely watching or not watching a television show. From this, the digital marketing system 106 may adjust a bid as part of an online auction to control output of the digital marketing content, an example of which is further described in relation to FIGS. 2-6.

In another example, the score generated by the scoring module 134 indicates a sentiment expressed by the user population with respect to the digital content 114. Natural language understanding techniques, for instance, may be employed as part of machine learning to learn sentiment expressed in the text, through use of graphical elements (emoji's), and so on in the social network communications 130 included in the social network data 126, e.g., as having particular hashtags. A score generated from this information by the scoring module 134 may thus exhibit which sentiments are exhibited by the user population in the social network communications 130 and even amounts of those sentiments (e.g., from “−1” to “+1”), which may give further insight into potentially successful digital marketing. This example is also further described in relation to FIGS. 2-6.

The scoring module 134 may also be used to improve accuracy in the selection of digital marketing content 122 by the digital marketing system 106 through the use of topics, e.g., hashtags. The digital marketing system 106, for instance, may obtain social network data 126 that describes a plurality of topics (e.g., hashtags) involving social network communications 130, e.g., trending topics associated with respective hash tags. The digital marketing system 106 then identifies which of topics are relevant to digital marketing content 122 based on respective social network communications 130 associated with the topics.

The social network communications 130, for instance, may be processed using natural language understanding to determine whether the communications include product mentions, are in the same field of endeavor, involve similar activities, and so forth. A score is then generated by the scoring module 134 to indicate whether the identified topics are likely to have a negative or positive effect on conversion of a good or service associated with the digital marketing content 122.

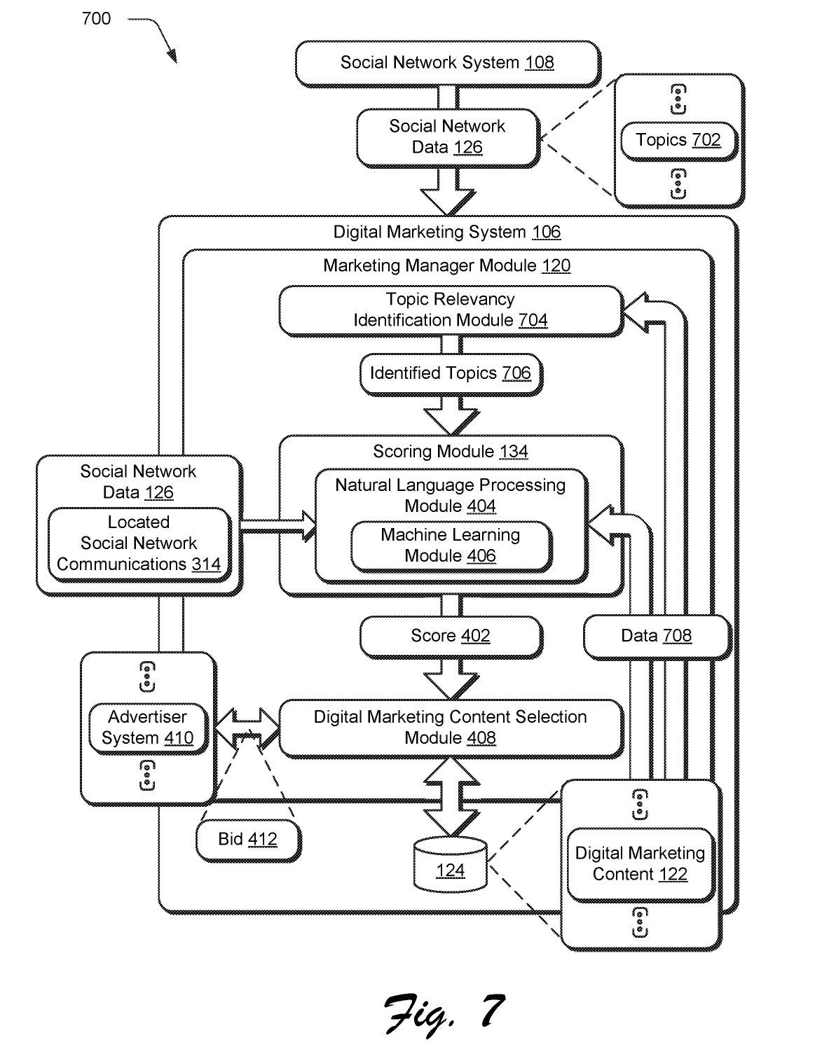

The digital marketing content 122, for instance, may relate to a beach scene. The topic described in the social network data 126, however, may relate to flooding. Accordingly, the digital marketing content 122 is relevant to the topic, but would have a negative effect on conversion of a service, e.g., to purchase a corresponding beach vacation. As a result, through use of natural language processing, the digital marketing system 106 may select digital marketing content 122 with increased accuracy by leveraging an external service system, e.g., a third-party social network system 108. Other external service systems are also contemplated, including digital content reviews from service provider systems. Further discussion of this example may be found in the following in relation to FIGS. 7-9.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

Digital Marketing Content Control and Determined Interests

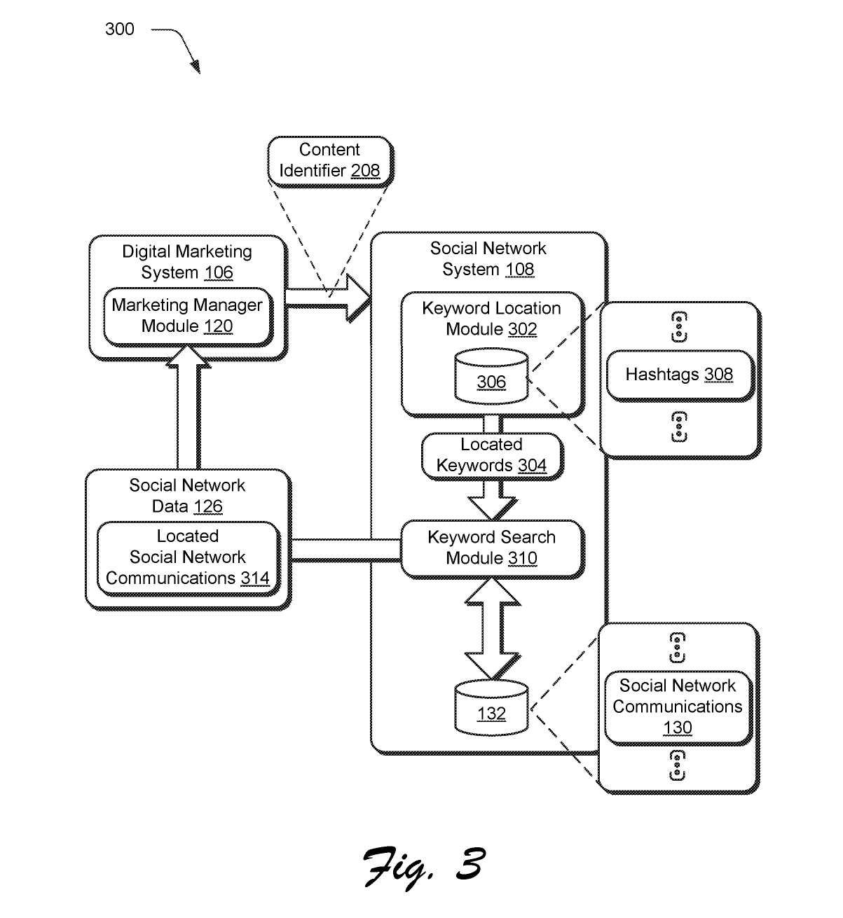

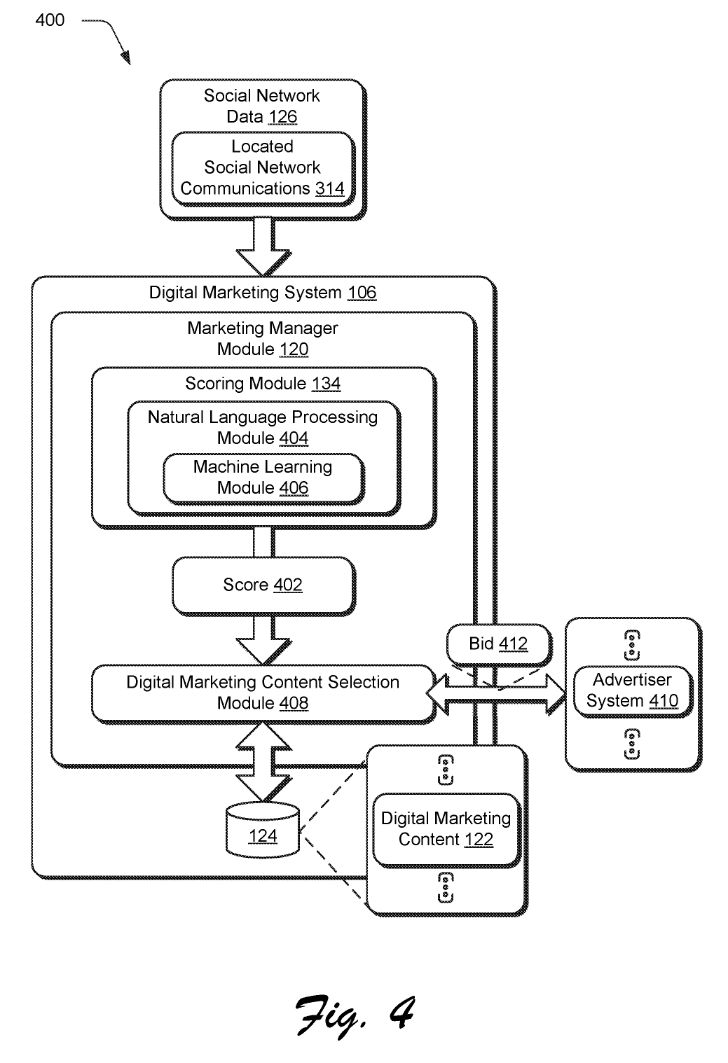

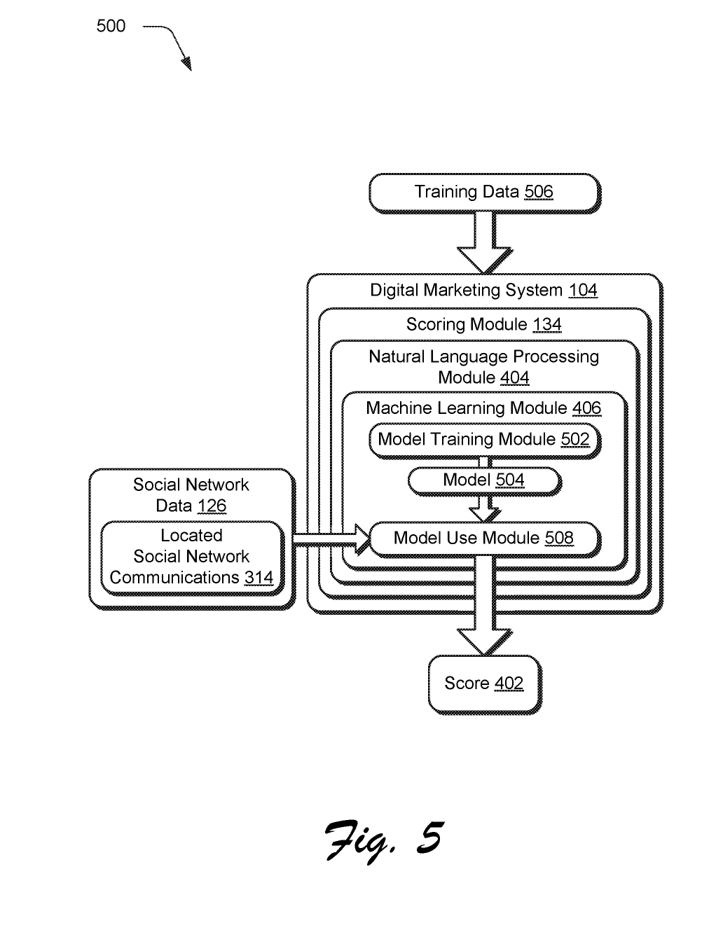

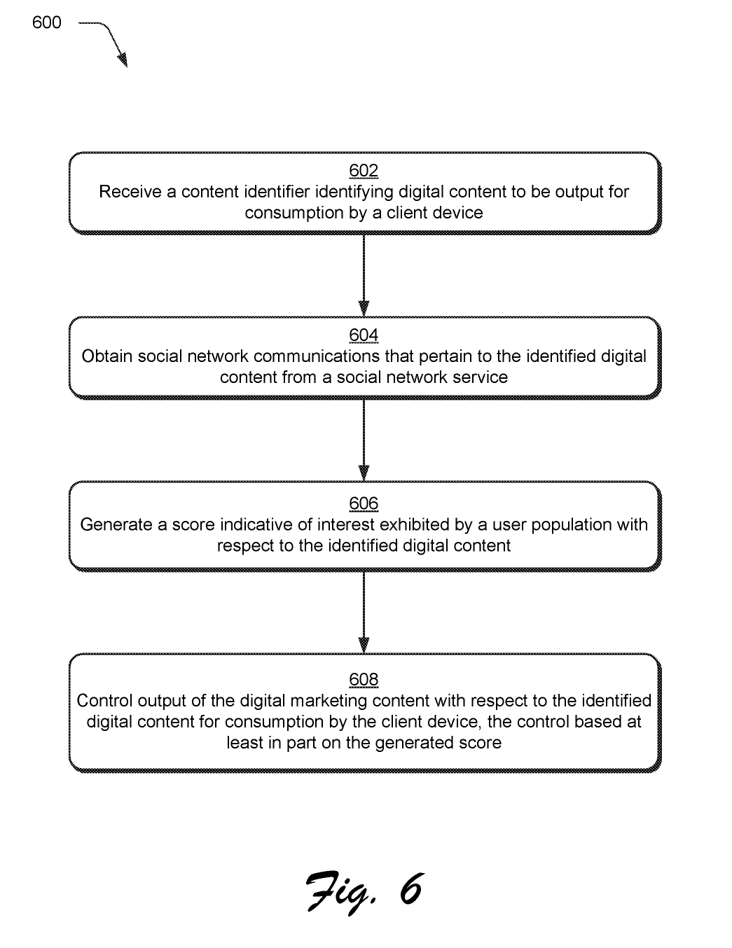

FIG. 2 depicts a system 200 in an example implementation in which output of digital marketing content is controlled based on a determination of user interests regarding digital content as determined from an external service system. FIG. 3 depicts a system 300 showing operation of a social network system 108 of FIG. 2 in greater detail as generating social network data 126 for use by the digital marketing system 106 to gain insight into user interests. FIG. 4 depicts a system 400 in an example implementation showing operation of the digital marketing system 106 in greater detail as employing natural language processing to process the social network data 126 of FIG. 3 to generate a score usable to control output of digital marketing content 122 based on user interests. FIG. 5 depicts operation of a machine learning module of the scoring module of FIG. 4 in greater detail to perform natural language processing. FIG. 6 depicts a procedure 600 in an example implementation in which a score is generated through natural language processing to indicate user interests.

The following discussion describes techniques that may be implemented utilizing the previously described systems and devices. Aspects of the procedure may be implemented in hardware, firmware, software, or a combination thereof. The procedure is shown as a set of blocks that specify operations performed by one or more devices and are not necessarily limited to the orders shown for performing the operations by the respective blocks. In portions of the following discussion, reference will be made to FIGS. 1-6.

In this example, interests of a user population regarding an item of digital content are determined with respect to digital content 114. This is used by a digital marketing system 106 to control output of digital marketing content 126 in conjunction with the digital content 114 for output to the client device 104. This includes selection of digital marketing content 126, a determination of a value of an opportunity to output the digital marketing content (e.g., to set a bid price as part of an online auction), and so on. The user interests are determined from an external service system, which may be configured in a variety of ways, such as a social network system 108 as illustrated, a review website, a digital content database, and so forth. Thus, although a social network system 108 is described in this example, other external service systems are also contemplated without departing from the spirit and scope thereof.

To begin, FIG. 2 is illustrated as including first and second stages 202, 204. At the first stage 202, digital content 114 is streamed as digital video 206 from a content provider system 102 to a client device 104 via a network 110, e.g., through use of a manifest and segment streaming technique over the Internet. The digital content 114, for instance, may be formed as a series of frames that are “live streamed” in real time as an event is captured or made available, such as a sporting event, an awards show, first airing of an episode of television, and so forth. Thus, in this example little if any knowledge regarding a user population's thoughts toward the content is made available before the streaming of the digital content 114.

As the digital content 114 is streamed, a content identifier 208 is also provided by the content provider system 102 to the digital marketing system 106 via the network 110. The content identifier 208 is used to uniquely identify the digital content 114 in this example, e.g., as a title taken from metadata associated with the digital content 114, a unique identifier used to identify a manifest to stream the digital content 114 from the content provider system 102, and so forth. As a result, the digital marketing system 106 receives the content identifier 208 that identifies digital content 114 to be output for consumption by the client device 104 (block 602), which may also be received from the client device 104, directly. The digital marketing system 106 then uses the content identifier 208 to obtain social network data 126 from the social network system 108 that pertains to the content identifier 208 and thus the digital content 114 as shown at the second stage 204 of FIG. 2.

FIG. 3 depicts a system 300 showing operation of the social network system 108 to generate the social network data 126 based on the content identifier 208 in this example. The social network system 108 includes a keyword location module 302 that is configured to locate keywords 304 that correspond to the content identifier 208 from a storage device 306. The keyword location module 302, for instance, may employ the content identifier 208 as an index to find the located keywords 304. The located keywords 304 may be configured in a variety of ways, including permutations of the content identifier 208, include additional keywords found based on the content identifier 208 (e.g., names of actors, geographic locations), and so on.

In another example, the located keywords 304 include hashtags 308 used by the social network system to index social network communications 130. A hashtag is a word or phrase preceded by a hash mark “#” that is used as part of (e.g., within) a social network communication 130 to identify a topic of interest and facilitate a search for it. A user, for interest, may include a hashtag “#ParticularTVShow is the best! !” as part of a social network communication 130 along with an emoticon and select “post” to cause transmittal of the communication to other users of the social network system 108. As a result, this social network communication 130 may be located by other users of the social network system 108 through use of the hashtag. In this way, users of the social network system 108 may communicate regarding a particular topic with others also interested in that topic.

This communication and keyword indexing may also be leveraged by the digital marketing system 106 to gain insight into those topics being discussed via the social network communications 130. In the illustrated example, the located keywords 304 (e.g., hashtags) are provided to a keyword search module 310 by the social network system 108. The located keywords 304 are used as part of a search to generate social network data 126. The social network data 126, for instance, may describe a number of mentions of the keyword in social network communications 130, trends indicated by those numbers, and so on. In another instance, the social network data 126 includes the located social network communications 314, e.g., posts via Instagram®, Facebook®, LinkedIn®, Tweets® from Twitter®, and so on. This generated social network data 126 is then communicated via the digital marketing system 106 to control output of digital marketing content 122.

FIG. 4 depicts a system 400 in an example implementation showing operation of the digital marketing system 106 to process the social network data 126 of FIG. 3 generate a score to identify interest of a user population of the social network system 108 in the digital content 114. Continuing with the previous example, social network data 126 is obtained by the digital marketing system in response to communication of the content identifier 208. The social network data 126 is then provided to a scoring module 134 to generate a score 402.

In this example, the score 402 is indicative of interest exhibited by a user population with respect of the identified digital content 114 (block 606). The score 402 may describe interest in a variety of ways. In one example, the score 402 is indicative of a level of interest of the user population in the identified digital content 114. The score 402, for instance, may be based on a number of social network communications 130 that are associated with the identified digital content 114, e.g., include a corresponding hashtag. This may be used to determine the level of interest and also changes in trends regarding this level of interest, e.g., is the level of interest in the digital content 114 rising or falling.

In another example, the score 402 is also indicative of a level of interest, but is determined through the use of a natural language processing module 404 and an associated machine learning module 406. The machine learning module 406, for instance, may be configured to incorporate statistical natural language processing. This type of processing uses statistical inference to learn rules automatically and without user intervention through use of training data, e.g., a corpus of words and phrases as described further in relation to FIG. 5.

FIG. 5 depicts a system 500 showing operation of the machine learning module 406 in greater detail to perform natural language processing. The machine learning module 406 includes a model training module 502 that is configured to train the model 504 using training data 506. The machine learning module 406 also includes a model use module 508 that is configured to use the trained model 504 to process the located social network communications 314 to generate the score 402.

To train the model 504, the model training module 502 obtains training data 506 as a corpus of previous social network communications or other communications, documents, and so forth. From this, the model training module 502 using statistic inference to learning features from this training data 506 that are usable to determine interest of the user population. The training data 506, for instance, may be labeled (e.g., manually) to indicate relative high or low levels of interest for respective social network communications 130, e.g., manually tagged as a “−1” for not interested, “0” for somewhat interested, and “+1” for interested. This training data 506 is then used to locate features that correspond to these levels of interest that may then be used, once the model 504 is trained, to process the located social network communications to determine a level of interest exhibited by the user population in subsequent social network communications 130. The model 504, for instance, may be configured to make probabilistic decisions based on weights to each input feature identified through training of the model 504. As a result, the model 504 may address a variety of different possible answers through generation of the score 402 in expressing a level of interest of the user population in the digital content 114.

Returning again to FIG. 4, the score 402 (regardless of configuration) is then provided to a digital marketing content selection module 408 to control output of digital marketing content 122 (block 608). In the illustrated example, the score 402 is provided to a plurality of advertiser systems 410 via the network 110 of FIG. 1. The score 402 is then used as a basis to form a bid 412 by the advertiser systems 410 to be used as part of an online auction for the opportunity to include digital marketing content 122 for output in conjunction with the digital content 114. The bid 412, for instance, may be based on a budget specified by the advertiser system 410 along with identification of segments of a user population and so on as part of a marketing campaign. In another example, this functionality is incorporated by the digital marketing content selection module 408, itself, based on inputs received by the advertiser system 410, e.g., as a set of defined preferences.

In this way, control of the digital marketing content 122 may be based on insights gained from the social network system 108. For example, the digital content 114 may be configured as a television program of an awards show that is streamed in real time. Keywords in the located social network communications 314 are processed through machine learning to identify a level of interest by the user population, e.g., “I'm bored with #Awards-show,” or “#Awards-show is so amazing!” These keywords are then used by the scoring module 134 as part of natural language processing to define the score 402. The score, for instance, may vary from “−1” to “+1” to indicate relative amounts of interest, e.g., from “not interested” to “interested.”

The score 402 is then used by a digital marketing system 106 to control output of digital marketing content 122, such as to control an amount to bid 412 to cause output of digital marketing content 122 in conjunction with the digital content as part of an online auction. In this way, the digital marketing system is able to gain and leverage valuable insight into the digital content 114 from an external service system, even for live streaming digital content. This is not possible by conventional techniques that are limited to use of past user interactions.

In another example, user interest relates to a sentiment expressed by the user population in the located social network communications 314 with respect to the digital content 114. As above, the social network communications 130 are obtained by the digital marketing system. Natural language understanding techniques are then employed as part of machine learning to learn sentiment expressed in the text, graphical elements (emoji's), and so on in the social network communications.

Natural language understanding (NLU) is part of natural language processing that is tasked with understand “what” is included within the natural language. To do so, natural language understanding as implemented by the natural language processing module 404 includes functionality to address diverse syntax through use of a lexicon, a parser, and grammar rules to break a series of text (e.g., the located social network communications 314) into an internal representation using machine learning. In this way, the model 504 may be trained from training data 506 that includes these series of text and tags indicative of a sentiment expressed by the text. Once the model 504 is trained, the model use module 508 may process the located social network communications 314 to determine a sentiment expressed, respectively.

The located social network communications 314, for instance, may vary from “#sportingevent is truly awful” to “I love watching this #sportingevent, one of the best ever.” Accordingly, the model use module 508 may processes these communications to generate a score 402 based on these sentiments. The score 402, for instance, may thus exhibit which sentiments are exhibited by the user population and even amounts of those sentiments (e.g., from “−1” to “+1”), i.e., a “strength” of these sentiments. This may be used to gain further insight into selection of potentially successful digital marketing content 122.

Returning to FIG. 4, for instance, the digital marketing content selection module 408 may select digital marketing content 122 consistent with these sentiments. Continuing with the example above, this may include selection of digital marketing content 122 having the statement “well, at least you have your health” from a health care provider. This selection is made in this example in response to social network communications 314 that indicate the user population thinks, generally as learned through natural language processing of the communications, that “#sportingevent is truly awful.”

On the other hand, digital marketing content 122 is selected indicating “we're winners, just like #teamx at #sportingevent” when natural language processing of the social network communications indicates that the user population thinks, generally, that “I love watching this #sportingevent, one of the best ever.” As a result, the digital marketing system 106s may react in real time as insights are gained from the social network system to control output of digital marketing content, even for live streaming digital content which is not possible using conventional techniques and systems. Further, the digital marketing system 106 may do so for interests of a user population that may be expressed in a variety of ways, e.g., levels of interest, sentiments, and so forth. Similar techniques may also be employed for a variety of other external service systems, such as for digital content reviews of an aggregation web site.

Digital Marketing Content Control and Topics

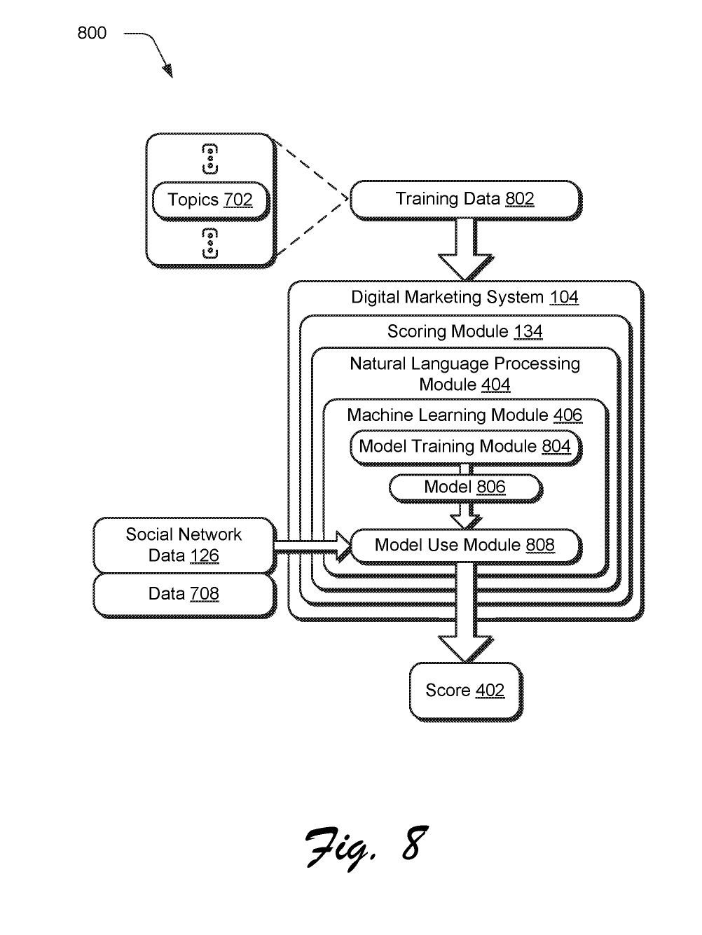

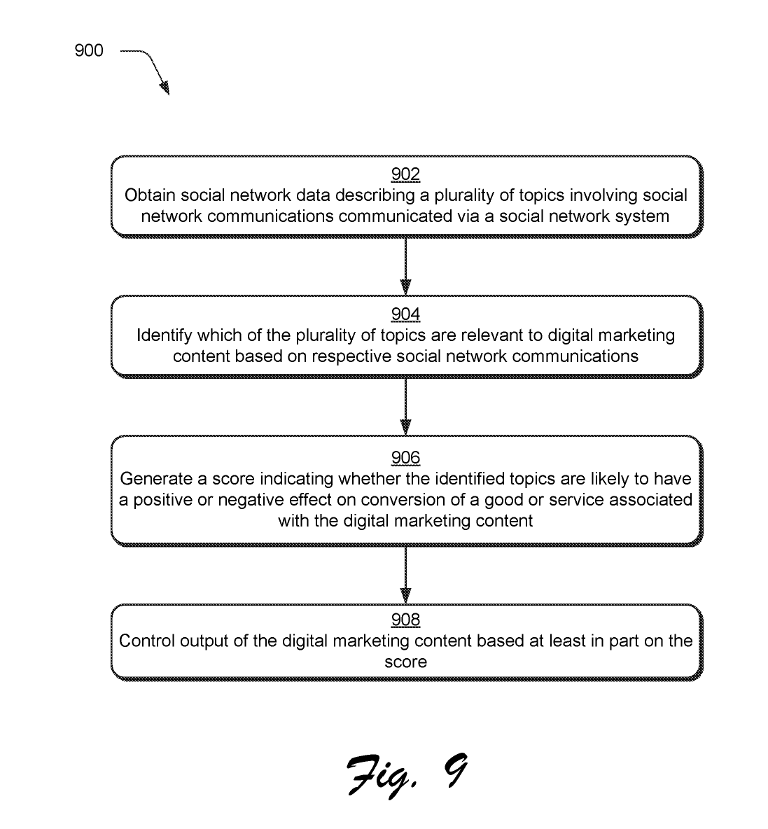

FIG. 7 depicts a system 700 in an example implementation in which topics of an social network system 108 are used, in part, to control output of digital marketing content. FIG. 8 depicts a system 800 in an example implementation in which operation of a natural language processing module is shown in greater detail as generating a score for a topic. FIG. 9 depicts a procedure 900 in an example implementation of identification of topic correlation to digital marketing content is used to control output of the digital marketing content.

The following discussion describes techniques that may be implemented utilizing the previously described systems and devices. Aspects of the procedure may be implemented in hardware, firmware, software, or a combination thereof. The procedure is shown as a set of blocks that specify operations performed by one or more devices and are not necessarily limited to the orders shown for performing the operations by the respective blocks. In portions of the following discussion, reference will be made to FIGS. 7-9.

In the previous section, interests of a user population with respect to an item of digital content were determined through use of a number of mentions of the digital content, natural language processing, and so forth. In this example, interests of a user population with respect to a particular topic and how those interests correspond to digital marketing content are used to control output of the digital marketing content. The topics (e.g., trending topics and corresponding hashtags), for instance, may be used to determine relevancy of those topics to digital marketing content. Social network communications that correspond to the topics that are determined relevant are then used to determine whether this relevancy is likely to have a positive or negative result on effectiveness of the digital marketing content 122. In this way, the digital marketing system 104 may promote network and computational efficiency in selection of the digital marketing content 122 and avoid potential harmful effects.

FIG. 7, for instance, illustrates communication of social network data 126 from the social network system 108 to the digital marketing system 106 via the network of FIG. 1 as before. The social network data 126 in this example indicates topics 702 that are a subject of the social network communications 130. The topics 702, for instance, may include trending topics that are subject to changes (e.g., over a threshold) in user popularity over a period of time as determined from social network communications 130 of the social network system 108. In another example, the topics 702 indicate the most popular topics to the user population as determined from social network communications 130 of the social network system 108.

Thus, the social network data 126 is obtained by the digital marketing system 106 that describes a plurality of topics involving social network communications 130 communicated via the social network system 108 (block 902). The social network data 126 is then processed by a topic relevancy identification module 704 to identify which of the plurality of topics 702 are relevant to digital marketing content based on respective social network communications (block 904) as identified topics 706. This identification may be performed in a variety of ways.

The topic relevancy identification module 706, for instance, may base this identification of similarity of keywords used to describe the digital marketing content 122 with similarity of keywords in data 708 used to describe the digital marketing content 122. The data 708, for instance may include a summary of the digital marketing content 122, metadata associated with the digital marketing content 122, text included as part of the digital marketing content 122, and so forth.

A score may be generated indicative of an amount of relevancy (e.g., from “−1” to “+1”) of the keywords to each other through natural language processing. Scores over a threshold indicative of at least a minimal level of relevancy are then included as part of the identified topics 706. For example, a score computed for the keyword “desert” as a topic 702 and keyword “thirst quenching” from the data 708 of the digital marketing content 122 may be considered relevant to each other. However, the keyword “desert” as the topic 702 and keyword “healthcare” may be minimally relevant to each other as indicated by the score. This determination of relevancy using the keywords may be further aided through natural language processing and natural language understanding techniques as described in the previous section through machine learning to further improve this accuracy by understanding a sentiment expressed by the topics and digital marketing content 122.

The identified topics 706 are then provided to the scoring module 134. A score 402 is generated indicating whether the identified topics are likely to have a positive or negative effect on conversion of a good or service associated with the digital marketing content 122 (block 906). The data 708 describing the digital marketing content 122, for instance, may be processed along with located social network communications 314 corresponding to the identified topics 706 using natural language processing techniques and machine learning to generate a score 402 indicative of a likely positive or negative effect of the topic 702 on the digital marketing content 122 as further described in the following example.

FIG. 8 depicts a system 800 in an example implementation showing operation of the machine learning module 406 of FIG. 7 in greater detail as generating a score 402 indicative of a likely positive or negative effect of topics 702 on digital marketing content 122. In this example, training data 802 is obtained and used by a model training module 804 to train a model 806 using machine learning, e.g., to learn weights for features form the training data 802. The model 806 is then employed by a model use module 808 to process data 708 describing the digital marketing content 122 to generate a score 402 indicative of relevancy of the topics 702 to the digital marketing content 122.

The training data 802, for instance, may pertain to a particular topic 702. The training data 802 also includes data that relates to these topics and a corresponding tag (e.g., score) that indicates a likely positive of negative effect of the data to the topic. The training data, for instance, may include social network communications that are tagged as relating positively or negatively to a respective topic. This training data is then used to identify weights for features that are indicative of the positive or negative effect for the topic to train the model 806 using machine learning.

The model training module 804, for instance, may employ natural language understanding to understand “what” is included within the natural language in the training data 802 as described in the previous section. To do so, natural language understanding as implemented by the natural language processing module 804 includes functionality to address diverse syntax through use of a lexicon, a parser, and grammar rules to break a series of text in the training data 802 into an internal representation using machine learning to determine “what” is expressed in the text.

Once the model 806 is trained, the model use module 808 may process the social network data 126 having located social network communications 314 that correspond to the topic and data 708 describing the digital marketing content 122. This is used to generate a score 402 indicative of a likely positive or negative effect of the topic 702 to respective items of digital marketing content 122, e.g., from “+1” to “−1.”

Output of the digital marketing content is then controlled by the digital marketing content selection module 408 based at least in part on the score 402 (block 908). The digital marketing content 122, for instance, may relate to a beach scene. The topic 702 described in the social network data 126, however, may relate to flooding. The score 402 may thus indicate that the topic 702 is likely to have a negative effect on conversion of a good or service described by the digital marketing content 122. As a result, the digital marketing system 106 may reduce and even prevent potentially harmful output of potentially harmful digital marketing content 122 through this insight. Likewise, the digital marketing system 106 may also promote accuracy in selection of digital marketing content 122 through identification of a likely positive effect of the topic 702 on the digital marketing content 122 and thus conversion of a good or service described by the content. This may be used to adjust bids or other control (e.g., to bid or not to bid) as previously described. Again, although a social network system 108 is described other external service systems are also contemplated without departing from the spirit and scope thereof, e.g., a content review website.

Example System and Device

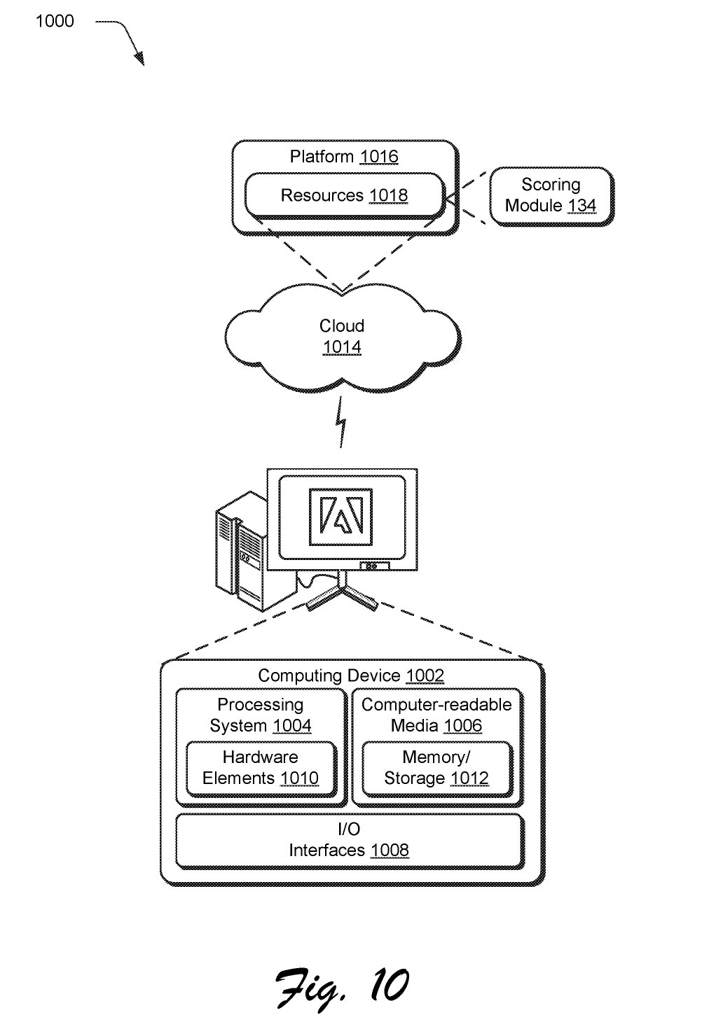

FIG. 10 illustrates an example system generally at 1000 that includes an example computing device 1002 that is representative of one or more computing systems and/or devices that may implement the various techniques described herein. This is illustrated through inclusion of the scoring module 134. The computing device 1002 may be, for example, a server of a service provider, a device associated with a client (e.g., a client device), an on-chip system, and/or any other suitable computing device or computing system.

The example computing device 1002 as illustrated includes a processing system 1004, one or more computer-readable media 1006, and one or more I/O interface 1008 that are communicatively coupled, one to another. Although not shown, the computing device 1002 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware element 1010 that may be configured as processors, functional blocks, and so forth. This may include implementation in hardware as an application specific integrated circuit or other logic device formed using one or more semiconductors. The hardware elements 1010 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1006 is illustrated as including memory/storage 1012. The memory/storage 1012 represents memory/storage capacity associated with one or more computer-readable media. The memory/storage component 1012 may include volatile media (such as random access memory (RAM)) and/or nonvolatile media (such as read only memory (ROM), Flash memory, optical disks, magnetic disks, and so forth). The memory/storage component 1012 may include fixed media (e.g., RAM, ROM, a fixed hard drive, and so on) as well as removable media (e.g., Flash memory, a removable hard drive, an optical disc, and so forth). The computer-readable media 1006 may be configured in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1002. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1002, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1010. The computing device 1002 may be configured to implement particular instructions and/or functions corresponding to the software and/or hardware modules. Accordingly, implementation of a module that is executable by the computing device 1002 as software may be achieved at least partially in hardware, e.g., through use of computer-readable storage media and/or hardware elements 1010 of the processing system 1004. The instructions and/or functions may be executable/operable by one or more articles of manufacture (for example, one or more computing devices 1002 and/or processing systems 1004) to implement techniques, modules, and examples described herein.

The techniques described herein may be supported by various configurations of the computing device 1002 and are not limited to the specific examples of the techniques described herein. This functionality may also be implemented all or in part through use of a distributed system, such as over a “cloud” 1014 via a platform 1016 as described below.

The cloud 1014 includes and/or is representative of a platform 1016 for resources 10110. The platform 1016 abstracts underlying functionality of hardware (e.g., servers) and software resources of the cloud 1014. The resources 10110 may include applications and/or data that can be utilized while computer processing is executed on servers that are remote from the computing device 1002. Resources 10110 can also include services provided over the Internet and/or through a subscriber network, such as a cellular or Wi-Fi network.

The platform 1016 may abstract resources and functions to connect the computing device 1002 with other computing devices. The platform 1016 may also serve to abstract scaling of resources to provide a corresponding level of scale to encountered demand for the resources 10110 that are implemented via the platform 1016. Accordingly, in an interconnected device embodiment, implementation of functionality described herein may be distributed throughout the system 1000. For example, the functionality may be implemented in part on the computing device 1002 as well as via the platform 1016 that abstracts the functionality of the cloud 1014.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment to control digital marketing content output with respect to digital content, a method implemented by at least one computing device, the method comprising:
receiving, by the at least one computing device, a content identifier identifying digital content to be output for consumption by a client device;
obtaining, by the at least one computing device, social network communications that pertain to the identified digital content from a social network system;
generating, by the at least one computing device, a score indicative of interest exhibited by a user population with respect to the identified digital content, the generating performed by processing the social network communications using natural language processing as part of machine learning; and
controlling, by the at least one computing device, output of the digital marketing content with respect to the identified digital content for consumption by the client device, the controlling based at least in part on the generated score.

2. The method as described in claim 1, wherein the score indicates an amount of interest exhibited by the user population with respect to the identified digital content.

3. The method as described in claim 2, wherein the controlling causes adjustment of a bid price to control output of the digital marketing content automatically and without user intervention based on the score.

4. The method as described in claim 1, wherein the score indicates a sentiment expressed by the user population in respective said social network communications regarding the identified digital content.

5. The method as described in claim 4, wherein the controlling causes adjustment of a bid price to control output of the digital marketing content automatically and without user intervention based on the score.

6. The method as described in claim 1, wherein the obtaining includes transmitting the content identifier to the social network system to cause the social network system to perform a search for the social network communications.

7. The method as described in claim 6, wherein the content identifier is configured to cause the social network system to locate at least one keyword as a hashtag that corresponds to the content identifier and perform the search using the hashtag.

8. The method as described in claim 1, wherein the digital content is digital video that is streamed to the client device and the receiving, the obtaining, the generating, and the controlling are performed during the streaming of the digital content to cause output of the digital marketing content in conjunction with the digital video.

9. The method as described in claim 1, wherein the natural language processing using machine learning includes statistical natural language processing by the at least one computing device in which probabilistic decisions are made based on weights associated with input features detected from the social network communications.

10. In a digital medium environment to control output of digital marketing content, a method implemented by at least one computing device, the method comprising:
obtaining, by the at least one computing device, social network data describing a plurality of topics involving social network communications communicated via a social network system;
identifying, by the at least one computing device, which of the plurality of topics are relevant to the digital marketing content based on respective said social network communications;
generating, by the at least one computing device, a score indicating whether the identified topics are likely to have a positive or negative effect on conversion of a good or service associated with the digital marketing content, the generating based on natural language processing of respective said social network communications using machine learning; and
controlling, by the at least one computing device, output of the digital marketing content based at least in part on the score.

11. The method as described in claim 10, wherein the identification of the positive or negative effect as part of the generating is based on a sentiment expressed in respective said social network communications learned through the natural language processing using machine learning.

12. The method as described in claim 10, wherein the identifying is based on a keyword comparison between data describing the digital marketing content and the social network data.

13. The method as described in claim 10, wherein the identifying is performed based on natural language processing of the social network data and data describing the digital marketing content using machine learning.

14. The method as described in claim 10, wherein the plurality of topics are identified as trending by the social network system.

15. In a digital medium environment to control digital marketing content output with respect to digital content, a system comprising:
means for obtaining social network communications from a social network system, the social network communications pertaining to digital content;
means for generating a score indicative of interest exhibited by a user population with respect to the identified digital content, the generating means including means for processing the social network communications using natural language processing as part of machine learning; and
means for controlling output of the digital marketing content with respect to the digital content based at least in part on the generated score.

16. The system as described in claim 15, wherein the score indicates an amount of interest exhibited by the user population with respect to the identified digital content.

17. The system as described in claim 16, wherein the controlling means causes adjustment of a bid price to control output of the digital marketing content automatically and without user intervention based on the score.

18. The system as described in claim 15, wherein the score indicates a sentiment expressed by the user population in respective said social network communications regarding the identified digital content.

19. The system as described in claim 18, wherein the controlling means causes adjustment of a bid price to control output of the digital marketing content automatically and without user intervention based on the score.

20. The system as described in claim 15, wherein the obtaining is based on a hashtag that is associated with the digital content.
